(19) United States
(12) Patent Application Publication
(10) Pub. No.: US 2021/0265924 A1
(43) Pub. Date: Aug. 26, 2021

(54) ACTUATOR DEVICE AND METHOD FOR MANUFACTURING ACTUATOR DEVICE

(71) Applicant: DENSO CORPORATION, Kariya-city (JP)

(72) Inventors: Mari FUKADA, Kariya-city (JP); Haruhiko WATANABE, Kariya-city (JP); Takuma YAMAUCHI, Kariya-city (JP)

(21) Appl. No.: 17/317,410

(22) Filed: May 11, 2021

Related U.S. Application Data
(63) Continuation of application No. PCT/JP2019/039148, filed on Oct. 3, 2019.

(30) Foreign Application Priority Data
Nov. 14, 2018 (JP) 2018-213889

(51) Int. Cl. H02N 10/00; H05B 3/56

(52) U.S. Cl. CPC H02N 10/00; H05B 3/56

(57) ABSTRACT

An actuator device includes an operating member that deforms in response to a change in temperature, and a heating member that applies heat to the operating member. The operating member deforms in response to a change in temperature within a range in which a stress generated between the operating member and the heating member remains at or below an elastic limit of the operating member.

### CROSS REFERENCE TO RELATED APPLICATION

The present application is a continuation application of International Patent Application No. PCT/JP2019/039148 filed on Oct. 3, 2019, which designated the U.S. and claims the benefit of priority from Japanese Patent Application No. 2018-213889 filed on Nov. 14, 2018. The entire disclosures of all of the above applications are incorporated herein by reference.

### TECHNICAL FIELD

The present disclosure relates to an actuator device, and a method for manufacturing the actuator device.

### BACKGROUND

An actuator device outputs a driving force using deformation of an operating member in response to a change in temperature.

### SUMMARY

An actuator device includes an operating member that deforms in response to a change in temperature, and a heating member that applies heat to the operating member. The operating member deforms in response to a change in temperature within a range in which a stress generated between the operating member and the heating member remains at or below an elastic limit of the operating member.

### BRIEF DESCRIPTION OF THE DRAWINGS

FIG. 1 is a schematic view showing an actuator device according to a first embodiment.

FIG. 2 is an enlarged view in FIG. 1.

FIG. 3 is a cross-sectional view showing an area III of FIG. 1 in the first embodiment.

FIG. 4 is an enlarged cross-sectional view illustrating an actuator device of a comparative example at a portion corresponding to the area III of FIG. 1, in which a polymer fiber and a heating wire are transitioned from (a) to (b) and (b) to (c).

FIG. 5 is a diagram illustrating a pre-heating length of a winding locus represented as hypotenuse length of a right triangle when a polymer fiber is set to have a lower limit temperature in an imaginary state in which the heating wire is removed from the polymer fiber while the winding locus of the heating wire is left on the outer surface of the polymer fiber, in the first embodiment.

FIG. 6 is a diagram illustrating an after-heating length of the winding locus represented a hypotenuse length of a right triangle when the polymer fiber is set to have an upper limit temperature in the imaginary state in the first embodiment.

FIG. 7 is a graph showing a relationship between a winding angle when the polymer fiber is set at the lower limit temperature and a pressure of a pressed portion at the upper limit temperature in the first embodiment.

FIG. 8 is a flowchart showing a process of manufacturing the actuator device in the first embodiment.

FIG. 9 is a schematic view showing an actuator device according to a second embodiment.

FIG. 10 is a diagram viewed in X direction in FIG. 9.

FIG. 11 is a cross-sectional view showing an actuator device according to a third embodiment, corresponding to FIG. 3.

FIG. 12 is a cross-sectional view showing an actuator device according to a fourth embodiment, corresponding to FIG. 3.

FIG. 13 is an enlarged view showing an actuator device according to a fifth embodiment.

FIG. 14 is a cross-sectional view taken along a line XIV-XIV in FIG. 13.

FIG. 15 is a cross-sectional view showing an actuator device according to a sixth embodiment, corresponding to FIG. 3.

### DESCRIPTION OF EMBODIMENT

To begin with, examples of relevant techniques will be described.

Conventionally, an actuator device outputs a driving force using deformation of an operating member in response to a change in temperature. For example, a polymer fiber actuator is known. The heat-driven polymer fiber actuator can generate a twisting or pulling operation by a change in temperature which is caused by electric heating or white heating.

In a heat-driven actuator device such as the polymer fiber actuator, the operating member is heated by the heating member. The operating member deforms in response to a change in temperature of the operating member. The deformation of the operating member is output as the power of the actuator device.

In such an actuator device, the heating member is heat-transferably connected to the operating member. The operating member thermally expands due to heating. The heating member may act mechanically so as to restrict the thermal expansion of the operating member depending on the configuration of the heating member. For example, in case where the heating member is wound around the operating member, when the operating member thermally expands so as to stretch the heating member, the heating member mechanically restricts the thermal expansion of the operating member.

When the heating member mechanically restricts the thermal expansion of the operating member in this way, the operating member deforms by being pressed by the heating member. If a stress that causes the deformation exceeds an elastic limit of the operating member, the operating member is plastically deformed. When the heating by the heating member is stopped after the operating member is plastically deformed, for example, a void is generated between the heating member and the operating member due to the plastic deformation. Thus, the thermal resistance between the heating member and the operating member increases. As a result of detailed studies by the inventors, the above-described issues have been found.

The present disclosure provides an actuator device capable of avoiding an increase in thermal resistance between a heating member and an operating member while the operating member is heated, and a method for manufacturing the actuator device.

According to one aspect of the present disclosure, an actuator device includes an operating member that deforms in response to a change in temperature, and a heating member that applies heat to the operating member. The operating member deforms in response to a change in temperature within a range in which a stress generated between the operating member and the heating member remains at or below an elastic limit of the operating member.

In this way, even if the operating member deforms in response to a change in temperature, it is possible to restrict the operating member from being plastically deformed due to the stress generated between the operating member and the heating member. Therefore, when the heating is stopped after the operating member is heated by the heating member, the operating member returns to its original shape which is before being heated by the heating member. Therefore, it is possible to restrict the thermal resistance between the heating member and the operating member from increasing due to heating of the operating member.

According to another aspect of the present disclosure, an actuator device includes:

a wire-shaped operating member that deforms in response to change in temperature;

a heating member wound around the outer surface of the operating member to heat the operating member; and

an urging member that urges the heating member to press against the operating member.

In this way, even if the operating member is plastically deformed by being pressed by the heating member due to thermal expansion of the operating member, the heating member can be maintained as pressed against the operating member due to the urging force of the urging member. Therefore, it is possible to restrict the thermal resistance between the heating member and the operating member from increasing due to heating of the operating member.

According to another aspect of the present disclosure, an actuator device includes:

a wire-shaped operating member that deforms in response to change in temperature; and

a heating member wound around the outer surface of the operating member to heat to the operating member.

The heating member has elasticity that elastically deforms in the radial direction of the heating member, and presses the operating member by the elasticity.

In this way, even if the operating member is plastically deformed by being pressed by the heating member due to thermal expansion of the operating member, the heating member can be maintained to press the operating member using the elasticity of the heating member. Therefore, it is possible to restrict the thermal resistance between the heating member and the operating member from increasing due to heating of the operating member.

According to another aspect of the present disclosure, an actuator device includes:

a wire-shaped operating member that deforms in response to change in temperature; and

a heating member that applies heat to the operating member.

The operating member expands in the radial direction of the operating member as the temperature of the operating member increases, and

the heating member is provided so as to extend along the axial direction of the operating member.

In this way, the heating member does not restrict the operating member from expanding in the radial direction, so that it is possible to avoid plastic deformation of the operating member due to the heating member. Therefore, when the heating is stopped after the operating member is heated by the heating member, the operating member returns to its original shape which is before being heated by the heating member. Therefore, it is possible to restrict the thermal resistance between the heating member and the operating member from increasing due to heating of the operating member.

According to another aspect of the present disclosure, a method of manufacturing an actuator device,

in which the actuator device includes: a wire-shaped operating member that deforms in response to change in temperature; and a heating member that applies heat to the operating member, the temperature of the operating member is changed between a predetermined lower limit temperature and a predetermined upper limit temperature higher than the predetermined lower limit temperature, the method of manufacturing the actuator device including:

preparing the operating member that expands in the radial direction of the operating member and contracts in the axial direction of the operating member as the temperature of the operating member rises;

preparing the heating member; and

winding the heating member around the outer surface of the operating member according to a winding locus of the heating member assumed on the outer surface of the operating member, after preparing the operating member and the heating member,

in the winding, the winding locus is determined so that a difference between a pre-heating length of the winding locus when the operating member is set to the lower limit temperature, before the heating member is wound, and an after-winding length of the winding locus when the operating member is set to the upper limit temperature, before the heating member is wound, is equal to or less than a predetermined limit value based on the elastic limit of the operating member.

In this way, it is possible to wind the heating member around the operating member, such that the stress generated between the operating member and the heating member is equal to or less than the elastic limit of the operating member, while the heating member is pulled by the thermal expansion of the operating member of the actuator device. Therefore, even if the operating member deforms in response to change in temperature in the actuator device, it is possible to restrict the operating member from being plastically deformed due to the stress generated between the operating member and the heating member. That is, when the operating member is heated by the heating member and then the heating is stopped, the operating member returns to the original shape which is before being heated by the heating member. Therefore, it is possible to avoid an increase in thermal resistance between the heating member and the operating member due to heating of the operating member.

The reference numerals attached to the components and the like indicate an example of correspondence between the components and the like and specific components and the like described in an embodiment to be described below.

Hereinafter, embodiments will be described with reference to the drawings. In the following embodiments, the same reference numeral is given to the same or equivalent parts in the drawings.

### First Embodiment

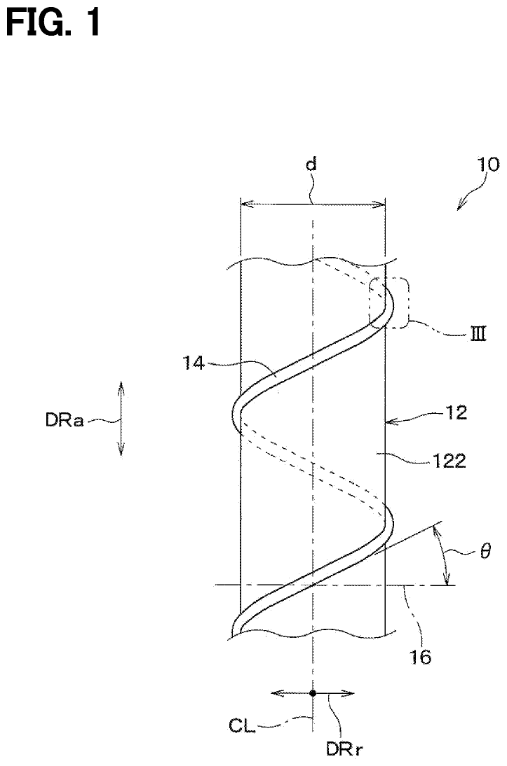

As shown in FIG. 1, an actuator device 10 of the present embodiment is formed in a string shape extending along a predetermined axis CL. The cross-section of the actuator device 10 orthogonal to the axis CL is formed in a substantially circular shape. The actuator device 10 can output power as an axial expansion/contraction operation of the actuator device 10 or a twisting operation around the axis CL in response to a rise in temperature due to heating.

The actuator device 10 includes a polymer fiber 12 and a heating wire 14.

The polymer fiber 12 is an operating member that deforms in response to a change in temperature of the polymer fiber 12 itself. Therefore, the polymer fiber 12 functions as a power source for the actuator device 10, and the deformation operation of the polymer fiber 12 is the output of the actuator device 10. The polymer fiber 12 is in the form of a wire, and extends along the axis CL. The axis CL is the central axis of the polymer fiber 12. The polymer fiber 12 is formed so that, for example, the cross section has a substantially circular shape.

The arrow DRa in FIG. 1 indicates the axial direction DRa of the polymer fiber 12, and the arrow DRr indicates the radial direction DRr of the polymer fiber 12. In the present embodiment, the axial direction of the actuator device 10 is the same as the axial direction DRa of the polymer fiber 12, and the radial direction of the actuator device 10 is the same as the radial direction DRr of the polymer fiber 12. In the following description, the axial direction DRa of the polymer fiber 12 may be referred to as the fiber axial direction DRa, and the radial direction DRr of the polymer fiber 12 may be referred to as the fiber radial direction DRr.

The polymer fiber 12 is composed of, for example, resin fibers. The polymer fiber 12 has a characteristic of being deformed in response to a change in temperature as a characteristic of the polymer fiber 12 itself. Specifically, the higher the temperature of the polymer fiber 12, the more the polymer fiber 12 expands in the fiber radial direction DRr and contracts in the fiber axial direction DRa while being twisted and deformed.

For example, the polymer fiber 12 is configured so that the higher the temperature of the polymer fiber 12, the more the polymer fiber 12 twists in the same direction as the winding direction of the heating wire 14. In the present embodiment, the deformation of the polymer fiber 12 in response to a change in temperature is also referred to as thermal deformation of the polymer fiber 12.

The heating wire 14 is a heating member that applies heat to the polymer fiber 12 in order to deform the polymer fiber 12. The heating wire 14 is in the form of a wire rod, and is made of, for example, a metal wire. The heating wire 14 is remarkably thinner than the polymer fiber 12, and is formed so that, for example, the cross section has a substantially circular shape.

The heating wire 14 is spirally wound around the outer surface of the polymer fiber 12 at a predetermined winding angle θ. As a result, the heating wire 14 is connected to the polymer fiber 12 so as to be heat transferable. The winding angle θ of the heating wire 14 is specifically represented by an angle formed by the heating wire 14 with respect to an imaginary plane 16 orthogonal to the axis CL.

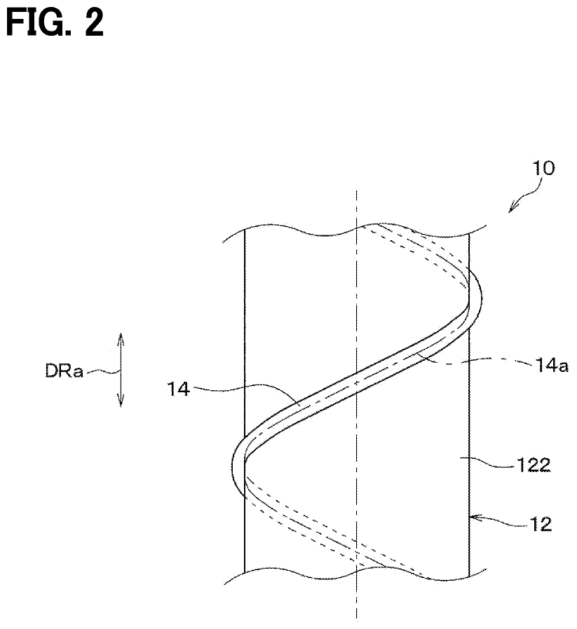

For example, as shown in FIG. 2, a winding locus 14a of the heating wire 14 is assumed on the outer surface of the polymer fiber 12. The winding locus 14a is formed so as to extend spirally with the winding angle θ on the outer surface of the polymer fiber 12. The heating wire 14 is wound around the outer surface of the polymer fiber 12 according to the winding locus 14a of the heating wire 14 assumed on the outer surface of the polymer fiber 12.

As a confirmation, since the winding locus 14a of the heating wire 14 is assumed to be on the outer surface of the polymer fiber 12, if the polymer fiber 12 deforms, the winding locus 14a deforms following the deformation of the polymer fiber 12. Further, since the winding locus 14a is a virtual one assumed on the outer surface of the polymer fiber 12, the physical shape is not generated on the outer surface of the polymer fiber 12 by the winding locus 14a.

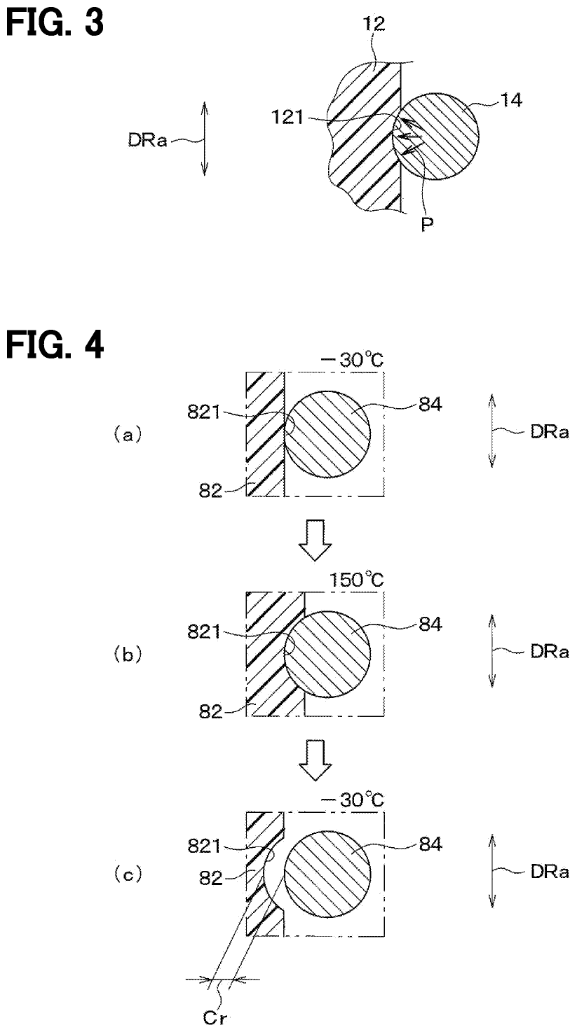

Specifically, as shown in FIGS. 1 and 3, the polymer fiber 12 has a wound portion 122 around which the heating wire 14 is wound, and has a pressed portion 121 to which the heating wire 14 comes into contact as a part of the wound portion 122. The heating wire 14 is wound so as to be in close contact with the polymer fiber 12, and constantly presses the pressed portion 121 of the polymer fiber 12 inward in the fiber radial direction DRr. That is, the heating wire 14 always generates a contact pressure with respect to the polymer fiber 12.

As a result, the heat generated by the heating wire 14 is easily transferred to the polymer fiber 12. The heating wire 14 generates heat by electric current, and the polymer fiber 12 can be heated. Therefore, the polymer fiber 12 can be deformed by the heat given from the heating wire 14 to perform an expansion/contraction operation in the fiber axial direction DRa and a twisting operation around the axis CL.

Further, due to the thermal expansion and torsional deformation of the polymer fiber 12, the heating wire 14 is pulled as the temperature of the polymer fiber 12 increases. Therefore, the heating wire 14 strongly pushes the pressed portion 121 of the polymer fiber 12 inward of the fiber radial direction DRr because the heating wire 14 is pulled by the deformation of the polymer fiber 12 as the temperature of the polymer fiber 12 increases.

An actuator device of a comparative example will be described with reference to FIG. 4. The actuator device of the comparative example includes a polymer fiber 82 corresponding to the polymer fiber 12 of the present embodiment and a heating wire 84 corresponding to the heating wire 14 of the present embodiment. In the actuator device of the comparative example, the heating wire 84 is spirally wound around the outer surface of the polymer fiber 82, as in the actuator device 10 of the present embodiment. FIG. 4 includes (a) to (c), each of which is a cross-sectional view showing an enlarged portion in the actuator device of the comparative example, corresponding to the area III of FIG. 1.

In the comparative example, the polymer fiber 82 in (a) of FIG. 4 illustrates a state before being heated by the heating wire 84, in which the temperature of the polymer fiber 82 is −30° C. The heating wire 84 is in contact with the polymer fiber 82.

In (b) of FIG. 4, the polymer fiber 82 is heated to have temperature of 150° C. by energizing the heating wire 84 from the state of (a) in FIG. 4. As described above, when the temperature of the polymer fiber 82 rises, the polymer fiber 82 thermally expands in the fiber radial direction DRr, while the heating wire 84 wound around the polymer fiber 82 hinders the thermal expansion of the polymer fiber 82. Therefore, in the state of (b) in FIG. 4, the polymer fiber 82 pressed by the heating wire 84 deforms and a deformed portion 821 is recessed.

In (c) of FIG. 4, the temperature of the polymer fiber 82 is lowered from 150° C. to −30° C. by cutting off the energization of the heating wire 84 from the state of (b) in FIG. 4. In this way, when the temperature of the polymer fiber 82 returns to the temperature before heating, the diameter of the polymer fiber 82 also returns to the state before heating.

If all the deformation of the deformed portion 821 of the polymer fiber 82 shown in (b) of FIG. 4 is elastic deformation, the shape of the deformed portion 821 also returns to that before heating. However, when the deformation of the deformed portion 821 includes plastic deformation, the shape of the deformed portion 821 does not return to that before heating as shown in (c) of FIG. 4. In the actuator device of the comparative example, the deformation of the deformed portion 821 of the polymer fiber 82 includes plastic deformation in the state of (b) in FIG. 4. Therefore, when the polymer fiber 82 returns to the temperature before heating, as shown in (c) of FIG. 4, a gap Cr is formed between the polymer fiber 82 and the heating wire 84. In this case, the heat of the heating wire 84 is less likely to be transferred to the polymer fiber 82.

As shown in FIG. 1, the actuator device 10 of the present embodiment is configured so that the gap Cr shown in (c) of FIG. 4 does not occur. That is, as shown in FIGS. 1 and 3, in the present embodiment, the polymer fiber 12 is not plastically deformed, and is elastically formed in response to change in temperature within a range where the contact stress P generated between the polymer fiber 12 and the heating wire 14 remains at or below an elastic limit Ps of the polymer fiber 12. The contact stress P is, in other words, the pressure P received by the pressed portion 121 of the polymer fiber 12 from the heating wire 14, or in other words, the compressive stress P generated on the pressed portion 121 while the heating wire 14 presses. In this embodiment, the contact stress P is also referred to as the pressure P of the pressed portion of the polymer fiber 12.

Specifically, in order to keep the pressure P of the pressed portion of the polymer fiber 12 at or below the elastic limit Ps of the polymer fiber 12, the actuator device 10 is used such that the temperature of the polymer fiber 12 changes within an allowable temperature range preset as a specification of the actuator device 10. That is, the temperature of the polymer fiber 12 is changed between a predetermined lower limit temperature TL when heat is not generated by the heating wire 14 and a predetermined upper limit temperature TH higher than the lower limit temperature TL. The lower limit temperature TL is a lower limit value in the allowable temperature range of the polymer fiber 12, and the upper limit temperature TH is an upper limit value in the allowable temperature range.

In the present embodiment, the higher the temperature of the polymer fiber 12, the higher the pressure P of the pressed portion of the polymer fiber 12. The pressure P of the pressed portion generated when the polymer fiber 12 has the upper limit temperature TH is less than or equal to the elastic limit Ps of the polymer fiber 12.

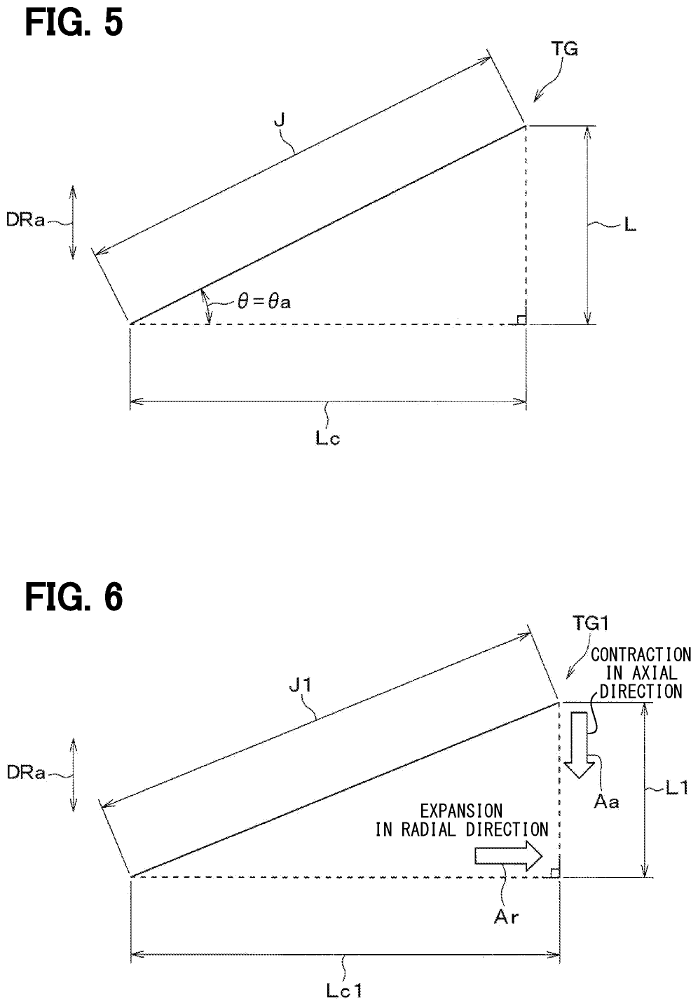

The winding angle θ of the heating wire 14 is set so that the pressure P of the pressed portion of the polymer fiber 12 remains at or below the elastic limit Ps of the polymer fiber 12, as described with reference to FIGS. 5 to 7.

The pressure P received by the pressed portion is increased by the heating wire 14 being pulled while the polymer fiber 12 deforms. For example, it is assumed that the heating wire 14 is removed from the polymer fiber 12 while the winding locus 14a of the heating wire 14 is left on the outer surface of the polymer fiber 12 in an imaginary state. In that case, it is considered that the pressure P of the pressed portion of the polymer fiber 12 does not increase unless the length of the winding locus 14a is extended even if the polymer fiber 12 is deformed by heat under the assumed imaginary state. The following explanation will be given based on this assumption.

As shown in FIGS. 5 and 6, the length J, J1 of the winding locus 14a can be expressed as a hypotenuse length of a right triangle TG, TG1 when developed on a plane. The right triangle TG in FIG. 5 represents a case where the polymer fiber 12 has the lower limit temperature TL. The hypotenuse length of the right triangle TG is the length J (that is, pre-heating length J) of the winding locus 14a when the polymer fiber 12 has the lower limit temperature TL under the imaginary state.

The right triangle TG1 in FIG. 6 represents a case where the polymer fiber 12 has the upper limit temperature TH. The hypotenuse length of the right triangle TG1 is the length J1 (that is, after-heating length J1) of the winding locus 14a when the polymer fiber 12 has the upper limit temperature TH under the imaginary state.

In the right triangle TG of FIG. 5, the length Lc is represented by Formula F1. The pre-heating length J in FIG. 5 is represented by Formula F2. The winding angle θ when the polymer fiber 12 has the lower limit temperature TL is an angle θa expressed by Formula F3.

Lc=Nπd [Formula F1]

J=\sqrt{(Nπd)²+L²} [Formula F2]

tan θa=L/(Nπd) [Formula F3]

In Formulas F1, F2, and F3, N is the number of windings of the heating wire 14 wound around the polymer fiber 12 having the lower limit temperature TL, and L is the axial length (that is, the length in the fiber axial direction DRa) of the wound portion 122 (see FIG. 1), around which the heating wire 14 is wound, of the polymer fiber 12 having the lower limit temperature TL. In other words, L is the axial length of the wound portion 122 when the polymer fiber 12 has the lower limit temperature TL, and d is the diameter of the polymer fiber 12 having the lower limit temperature TL. Strictly speaking, d is the diameter of the wound portion 122 having the lower limit temperature TL.

Further, in the right triangle TG1 of FIG. 6, the length Lc1 is represented by Formula F4. The axial length L1 of the wound portion 122 when the polymer fiber 12 has the upper limit temperature TH is represented by Formula F5. The after-heating length J1 in FIG. 6 is represented by Formula F6.

Lc1=(N+γ/360)(1+α·t)πd [Formula F4]

L1=(1+β·t)L [Formula F5]

J1=\sqrt{[(N+γ/360)(1+α·t)πd]²+[(1+β·t)L]²} [Formula F6]

In Formulas F4, F5, and F6, a is the coefficient of thermal expansion of the polymer fiber 12 in the fiber radial direction DRr (that is, the coefficient of thermal expansion in the radial direction), 13 is the coefficient of thermal expansion of the polymer fiber 12 in the fiber axial direction DRa (that is, the coefficient of thermal expansion in the axial direction), and t is the temperature difference between the lower limit temperature TL and the upper limit temperature TH. Then, γ is the twist angle of the polymer fiber 12 that twists when the polymer fiber 12 is raised in temperature from the lower limit temperature TL to the upper limit temperature TH. Strictly speaking, γ is the twist angle of the wound portion 122 that twists when the temperature of the polymer fiber 12 is raised from the lower limit temperature TL to the upper limit temperature TH. The twist angle γ is an angle preset as a specification of the actuator device 10.

The coefficients of thermal expansion a and 13 are both set by defining a positive direction in which the polymer fiber 12 thermally expands as expansion side. As the temperature of the polymer fiber 12 rises, the polymer fiber 12 expands as shown by an arrow Ar in the fiber radial direction DRr and contracts as shown by an arrow Aa in the fiber axial direction DRa. So, the thermal expansion coefficient α in the radial direction is a positive value, and the thermal expansion coefficient β in the axial direction is a negative value.

The unit of the twist angle γ of the wound portion 122 is “deg”, and the twist angle γ is used in Formulas F4 and F6, by defining a positive direction in which the deformation of the polymer fiber 12 is twisted in the same direction as the winding direction of the heating wire 14. In other words, the positive direction of the twist angle γ is defined as direction in which the polymer fiber 12 is twisted so as to increase the number of windings of the heating wire 14 wound around the polymer fiber 12.

Further, from Formulas F2 and F6, the difference ΔJ between the pre-heating length J and the after-heating length J1 of the winding locus 14a is represented by Formulas F7 and F8. In the present embodiment, the difference ΔJ may be referred to as a locus length difference ΔJ between before and after heating.

$$\begin{matrix}Δ J = J 1 - J & [ Formula F7 ] \\ Δ J = \sqrt{\begin{matrix}{[ \begin{matrix}( N + γ \text{/} 360 ) \\ ( 1 + α \cdot t ) π d\end{matrix} ]}^{2} + \\ {[ ( 1 + β \cdot t ) L ]}^{2}\end{matrix}} - \sqrt{{( N π d )}^{2} + {L}^{2}} & [ Formula F8 ]\end{matrix}$$

The locus length difference ΔJ between before and after heating has a relationship expressed by Formula F9 relative to an increase ΔP in the pressure P of the pressed portion of the polymer fiber 12 when the temperature of the polymer fiber 12 rises from the lower limit temperature TL to the upper limit temperature TH. Then, Formula F10 is derived by combining Formula F9 with Formulas F2 and F8. In Formulas F9 and F10, E is a constant that is the equivalent Young's modulus of the actuator device 10 configured as a composite material of the polymer fiber 12 and the heating wire 14.

$$\begin{matrix}Δ P = E \cdot Δ J \text{/} J = E ( J 1 - J ) \text{/} J & [ Formula F9 ] \\ Δ P = E \{ \sqrt{\frac{\begin{matrix}{[ ( N + γ \text{/} 360 ) ( 1 + α \cdot t ) π d ]}^{2} + \\ {[ ( 1 + β \cdot t ) L ]}^{2}\end{matrix}}{\sqrt{{( N π d )}^{2} + {L}^{2}}}} - 1 \} & [ Formula F10 ]\end{matrix}$$

Further, the pressure P of the pressed portion of the polymer fiber 12 having the upper limit temperature TH is defined as a pressed portion pressure Ph at the upper limit temperature, and is represented by Formula F11. Formula F12 is derived from Formulas F11 and F10. In Formulas F11 and F12, P0 represents the pressure P of the pressed portion of the polymer fiber 12 having the lower limit temperature TL. In the present embodiment, the heating wire 14 presses the pressed portion 121 of the polymer fiber 12 even when the polymer fiber 12 has the lower limit temperature TL. That is, the pressed portion pressure P0 at the lower limit temperature, which is the pressure P0 of the pressed portion of the polymer fiber 12 having the lower limit temperature TL, is larger than zero.

$$\begin{matrix}Ph = P0 + Δ P & [ Formula F11 ] \\ Ph = P 0 + E \{ \sqrt{\frac{\begin{matrix}{[ \begin{matrix}( N + γ \text{/} 360 ) \\ ( 1 + α \cdot t ) π d\end{matrix} ]}^{2} + \\ {[ ( 1 + β \cdot t ) L ]}^{2}\end{matrix}}{\sqrt{{( N π d )}^{2} + {L}^{2}}}} - 1 \} & [ Formula F12 ]\end{matrix}$$

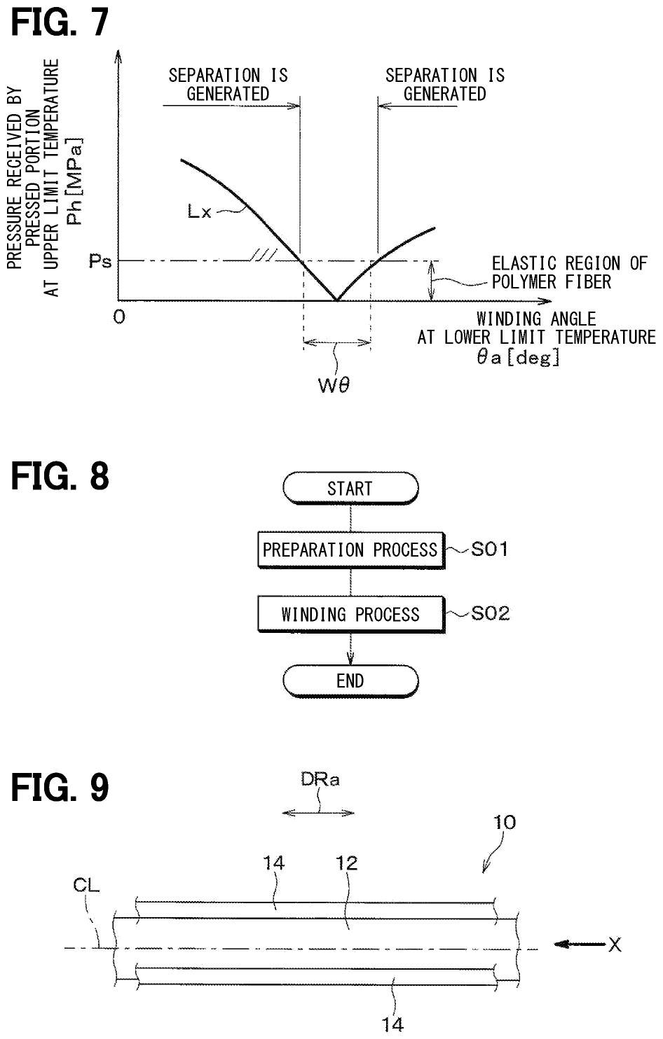

The curve Lx in FIG. 7 represents a relationship between the pressed portion pressure Ph at the upper limit temperature and the winding angle θa when the polymer fiber 12 has the lower limit temperature TL (that is, the winding angle θa at the lower limit temperature), using Formulas F12 and F3. Then, in the overpressure region where the pressure Ph of the pressed portion at the upper limit temperature indicated by the curve Lx exceeds the elastic limit Ps of the polymer fiber 12, the pressed portion 121 of the polymer fiber 12 is plastically deformed when the polymer fiber 12 reaches the upper limit temperature TH. Therefore, in the overpressure region, the heating wire 14 is separated away from the polymer fiber 12.

Therefore, in the present embodiment, the heating wire 14 is wound around the polymer fiber 12 so that the winding angle θa at the lower limit temperature falls within the allowable range W8 of FIG. 7. As a result, the polymer fiber 12 can deform according to the change in temperature between the lower limit temperature TL and the upper limit temperature TH while keeping the pressure P of the pressed portion of the polymer fiber 12 at or below the elastic limit Ps of the polymer fiber 12. In short, it is possible to optimize the winding angle θ of the heating wire 14 while excessive stress is not generated in the polymer fiber 12. The allowable range W8 of the winding angle in FIG. 7 indicates the range of the winding angle θa at the lower limit temperature, in which the pressure Ph of the pressed portion having the upper limit temperature is equal to or less than the elastic limit Ps of the polymer fiber 12.

For example, in the manufacturing process of the actuator device 10, the temperature of the polymer fiber 12 is set to the lower limit temperature TL and the heating wire 14 is wound around the polymer fiber 12. In this case, it is easy to keep the winding angle θa at the lower limit temperature within the allowable range W8. In such a case, the winding angle θa at the lower limit temperature is a winding angle at the time of assembling the actuator device 10, and the pressed portion pressure P0 of Formula F12 is a pressed portion pressure at the time of assembling (that is, initial pressure on the pressed portion).

Further, in the actuator device 10 of the present embodiment, since the pressure Ph of the pressed portion at the upper limit temperature is equal to or less than the elastic limit Ps of the polymer fiber 12, it can be said that Formula F13 obtained from Formula F11 is satisfied. Then, by modifying Formula F13 using Formula F9, Formula F14 is obtained. That is, by satisfying Formula F14, the polymer fiber 12 can deform according to the change in temperature between the lower limit temperature TL and the upper limit temperature TH while keeping the pressure P of the pressed portion of the polymer fiber 12 at or below the elastic limit Ps of the polymer fiber 12.

Ps≥P0+ΔP [Formula F13]

(Ps−P0)J/E≥ΔJ [Formula F14]

In Formula F14, “(Ps-P0) J/E” is a value determined based on the elastic limit Ps of the polymer fiber 12 as a predetermined limit value JL for the locus length difference ΔJ before and after heating. The locus length difference ΔJ before and after heating is equal to or less than the limit value JL. In this case, as can be seen from Formulas F11, F13, and F14, the limit value JL is the locus length difference ΔJ when the pressed portion pressure Ph at the upper limit temperature is identical to the elastic limit Ps. The locus length difference ΔJ when the pressure of the pressed portion at the upper limit temperature coincides with the elastic limit Ps is, in other words, a locus length difference ΔJ when the pressure P of the pressed portion of the polymer fiber 12 reaches the elastic limit Ps by being made to have the upper limit temperature TH. Formula F13 is based on a relational formula obtained by substituting the elastic limit Ps of the polymer fiber 12 for the pressure Ph of the pressed portion at the upper limit temperature in Formula F11.

Next, the manufacturing process (in other words, the assembly process) of the actuator device 10 will be described with reference to FIG. 8. First, in step S01 as a preparation process, the polymer fiber 12 and the heating wire 14 are prepared.

In step S02 as a winding process following step S01, the heating wire 14 is spirally wound at a predetermined winding angle θ on the outer surface of the polymer fiber 12 according to the assumed winding locus 14a (see FIG. 2) of the heating wire 14 around the outer surface of the polymer fiber 12. For example, after setting the temperature of the polymer fiber 12 to the lower limit temperature TL, the heating wire 14 is wound around the polymer fiber 12.

At this time, the winding locus 14a of the heating wire 14 is determined so that the locus length difference ΔJ before and after heating obtained from Formula F8 is equal to or less than the predetermined limit value JL. The limit value JL is described in the description of Formula F14. That is, the locus length difference ΔJ when the pressure P of the pressed portion of the polymer fiber 12 becomes the elastic limit Ps of the polymer fiber 12 by being set to have the upper limit temperature TH in the completed actuator device 10 is used as the limit value JL.

In the present embodiment, the heating wire 14 is wound around the outer surface of the polymer fiber 12 at the winding angle θ such that the pre-heating length J (see FIG. 5) of the winding locus 14a and the after-heating length J1 (see FIG. 6) of the winding locus 14a are the same or substantially the same as each other.

Since the heating wire 14 has not yet been wound around the polymer fiber 12 before the implementation of step S02, the pre-heating length J of the winding locus 14a of FIG. 5 and the after-heating length J1 of the winding locus 14a of FIG. 6 can be paraphrased as follows in step S02. That is, in step S02, the pre-heating length J of the winding locus 14a of FIG. 5 can be said as the length of the winding locus 14a when the polymer fiber 12 has the lower limit temperature TL before the heating wire 14 is wound. The after-heating length J1 of the winding locus 14a in FIG. 6 can be said as the length of the winding locus 14a when the polymer fiber 12 has the upper limit temperature TH before the heating wire 14 is wound.

The above is the manufacturing process of the actuator device 10.

As described above, according to the present embodiment, the polymer fiber 12 deforms in response to change in temperature within the range where the contact stress P of FIG. 3 generated between the polymer fiber 12 and the heating wire 14 (in other words, the pressure P of the pressed portion of the polymer fiber 12) remains at or below the elastic limit Ps of the polymer fiber 12. As a result, even if the polymer fiber 12 deforms in response to a change in temperature, the polymer fiber 12 is restricted from being plastically deformed by the pressure P of the pressed portion of the polymer fiber 12. Therefore, when the heating of the polymer fiber 12 is stopped after the polymer fiber 12 is heated by the heating wire 14, the polymer fiber 12 returns to the original shape which is before being heated by the heating wire 14. Therefore, it is possible to restrict the thermal resistance between the heating wire 14 and the polymer fiber 12 from increasing due to heating of the polymer fiber 12.

Further, according to the present embodiment, in step S02 of FIG. 8, the heating wire 14 is wound around the outer surface of the polymer fiber 12 according to the winding locus 14a (see FIG. 2) of the heating wire 14 assumed on the outer surface of the polymer fiber 12. The winding locus 14a of the heating wire 14 is determined so that the locus length difference ΔJ before and after heating obtained from Formula F8 is equal to or less than the predetermined limit value JL based on the elastic limit Ps of the polymer fiber 12. As a result, the pressure P of the pressed portion of the polymer fiber 12 generated by the heating wire 14 caused by the thermal expansion of the polymer fiber 12 of the actuator device 10 becomes equal to or less than the elastic limit Ps of the polymer fiber 12, when he heating wire 14 is wound around the polymer fiber 12. Therefore, as described above, it is possible to avoid an increase in the thermal resistance between the heating wire 14 and the polymer fiber 12 due to heating of the polymer fiber 12.

Further, according to the present embodiment, as shown in FIGS. 1 and 3, the heating wire 14 is wound around the outer surface of the polymer fiber 12. The heating wire 14 strongly presses the pressed portion 121 of the polymer fiber 12 inward of the fiber radial direction DRr because the heating wire 14 is pulled as the temperature of the polymer fiber 12 increases. Further, the compressive stress P (that is, the pressure P of the pressed portion) generated in the pressed portion 121, when the polymer fiber 12 is set to the upper limit temperature TH, is equal to or less than the elastic limit Ps of the polymer fiber 12. Therefore, in the actuator device 10 configured by winding the heating wire 14 around the outer surface of the polymer fiber 12, it is possible to avoid plastic deformation of the polymer fiber 12 by the heating wire 14.

Further, according to the present embodiment, the locus length difference ΔJ before and after heating is equal to or less than the predetermined limit value JL based on the elastic limit Ps of the polymer fiber 12. Therefore, the pressure P of the pressed portion of the polymer fiber 12 can be kept at or below the elastic limit Ps of the polymer fiber 12 by the method of winding the heating wire 14 around the polymer fiber 12.

Further, according to the present embodiment, the locus length difference ΔJ before and after heating is obtained by Formula F8. Therefore, the method of winding the heating wire 14 around the polymer fiber 12 is determined by using Formulas F8 and F14, so that the pressure P of the pressed portion of the polymer fibers 12 stays at or below the elastic limit Ps of the polymer fibers 12. After the method of winding the heating wire 14 is determined in advance, the heating wire 14 can be wound around the polymer fiber 12.

Further, according to the present embodiment, the limit value JL is the locus length difference ΔJ before and after heating, when the pressure P of the pressed portion of the polymer fiber 12 becomes the elastic limit Ps of the polymer fiber 12 as the polymer fiber 12 is set to the upper limit temperature TH. Therefore, it is possible to avoid the plastic deformation of the polymer fiber 12 by the heating wire 14, and it is possible to maximize the winding permissible range of the heating wire 14.

Further, according to the present embodiment, the heating wire 14 is wound around the outer surface of the polymer fiber 12, for example, at the winding angle θ at which the pre-heating length J (see FIG. 5) of the winding locus 14a and the after-heating length J1 (see FIG. 6) of the winding locus 14a are the same or substantially the same. In this way, even if the temperature of the polymer fiber 12 changes between the lower limit temperature TL and the upper limit temperature TH, the pressure P of the pressed portion of the polymer fiber 12 hardly fluctuates. Therefore, it is easy to avoid plastic deformation of the polymer fiber 12 caused by the heating wire 14.

Further, according to the present embodiment, the pressure P0 of the pressed portion at the lower limit temperature is larger than zero. Therefore, regardless of the temperature of the polymer fiber 12 from the lower limit temperature TL to the upper limit temperature TH, the heating wire 14 always generates a contact pressure with respect to the polymer fiber 12. Therefore, the thermal resistance between the heating wire 14 and the polymer fiber 12 can always be kept low by the contact pressure of the heating wire 14 with respect to the polymer fiber 12, as compared with a case where a gap Cr is formed between the heating wire 14 and the polymer fiber 12.

### Second Embodiment

A second embodiment is described next. The present embodiment will be explained primarily with respect to portions different from those of the first embodiment. In addition, explanations of the same or equivalent portions as those in the above embodiment will be omitted or simplified. The same applies to description of embodiments as described later.

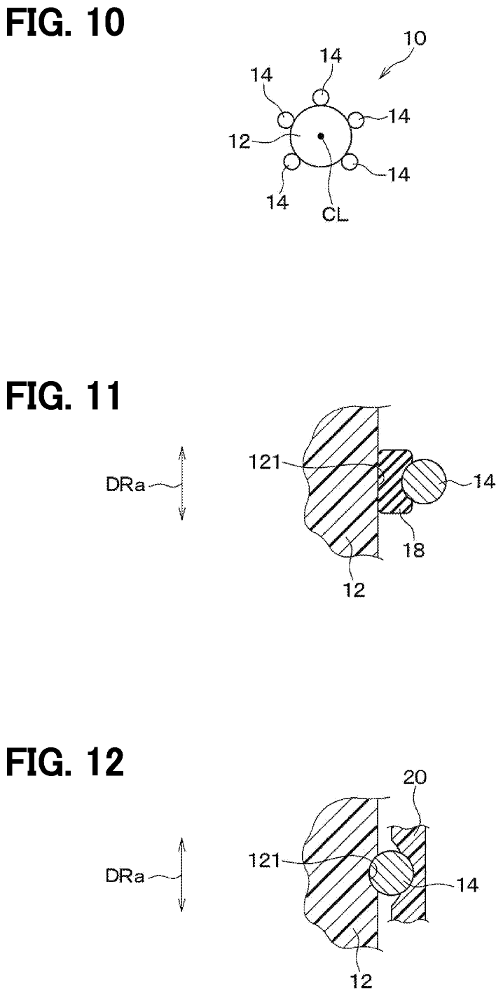

As shown in FIGS. 9 and 10, in the actuator device 10 of the present embodiment, the heating wire 14 is not wound around the outer surface of the polymer fiber 12. Specifically, the heating wire 14 is provided so as to extend along the fiber axial direction DRa. For example, the heating wire 14 is in contact with the polymer fiber 12 and is arranged parallel to the fiber axial direction DRa. For example, the heating wire 14 is bonded to the polymer fiber 12 so that the contact of the heating wire 14 with the polymer fiber 12 is maintained even if the polymer fiber 12 is thermally deformed.

Further, plural heating wires 14 are provided. The heating wires 14 are arranged along the outer surface of the polymer fiber 12 so as to be arranged at intervals around the axis CL of the polymer fiber 12.

According to the present embodiment, the heating wire 14 is not wound around the outer surface of the polymer fiber 12, but is provided so as to extend along the fiber axial direction DRa. As a result, the heating wire 14 does not restrict the polymer fiber 12 from expanding in the fiber radial direction DRr, so that the contact stress P generated between the polymer fiber 12 and the heating wire 14 is substantially zero. That is, the polymer fiber 12 deforms in response to a change in temperature within a range where the contact stress P generated between the polymer fiber 12 and the heating wire 14 remains at or below the elastic limit Ps of the polymer fiber 12. Therefore, it is possible to avoid plastic deformation of the polymer fiber 12 caused by the heating wire 14.

Therefore, when the heating of the polymer fiber 12 is stopped after the polymer fiber 12 is heated by the heating wire 14, the polymer fiber 12 returns to the original shape which is before being heated by the heating wire 14. That is, also in this embodiment, it is possible to avoid an increase in the thermal resistance between the heating wire 14 and the polymer fiber 12 due to heating of the polymer fiber 12.

Aside from the above described aspects, the present embodiment is the same as the first embodiment. Further, in the present embodiment, the same effects as the first embodiment described above can be obtained in the same manner as in the first embodiment.

### Third Embodiment

A third embodiment is described next. The present embodiment will be explained mainly with respect to portions different from those of the first embodiment.

As shown in FIG. 11, the actuator device 10 of the present embodiment includes an elastic member 18. The present embodiment is different from the first embodiment in this point.

Specifically, the elastic member 18 is made of, for example, silicon rubber or the like, and has high elasticity and high thermal conductivity. Specifically, the elastic member 18 is softer than the polymer fiber 12, and the elasticity of the elastic member 18 is higher than the elasticity of the polymer fiber 12. The heating wire 14 is wound, as shown in FIG. 1. In detail, as shown in FIG. 11, the heating wire 14 is wound around the outer surface of the fiber 12, while an elastic member 18 is interposed between the polymer fiber 12 and the heating wire 14.

For example, the elastic member 18 is interposed between the polymer fiber 12 and the heating wire 14 over the entire length of the wound portion 122 (see FIG. 1) of the polymer fiber 12. Therefore, the heat of the heating wire 14 is transferred to the polymer fiber 12 via the elastic member 18.

Further, the elastic member 18 is elastically deformed by being compressed by the polymer fiber 12 and the heating wire 14 as the polymer fiber 12 deforms according to the change in temperature. Therefore, due to the elasticity of the elastic member 18, it is possible to restrict a gap Cr (see FIG. 4) from being created between the heating wire 14 and the polymer fiber 12. Then, the heat of the heating wire 14 can be transferred to the polymer fiber 12 through the elastic member 18, and the polymer fiber 12 is restricted from being plastically deformed by being pressed by the heating wire 14 due to the elasticity of the elastic member 18.

Due to the elastic member 18, the present embodiment has no restriction that the heating wire 14 is wound around the polymer fiber 12 so that the winding angle θa at the lower limit temperature falls within the winding angle allowable range We of FIG. 7.

Aside from the above described aspects, the present embodiment is the same as the first embodiment. Further, in the present embodiment, the same effects as the first embodiment described above can be obtained in the same manner as in the first embodiment.

### Fourth Embodiment

A fourth embodiment is described next. The present embodiment will be explained mainly with respect to portions different from those of the first embodiment.

As shown in FIG. 12, the actuator device 10 of this embodiment includes an urging member 20. The present embodiment is different from the first embodiment in this point.

The urging member 20 of the present embodiment is made of, for example, a stretchable resin film. That is, the urging member 20 is in the form of a film and has high elasticity that can be expanded and contracted in the direction along the surface of the urging member 20.

Then, the urging member 20 is wound on the outer side of the heating wire 14 in the fiber radial direction DRr, while the heating wire 14 is wound around the outer surface of the polymer fiber 12, in a state of being stretched in the circumferential direction around the axis CL (see FIG. 1). Therefore, the urging member 20 always urges the heating wire 14 to be pressed against the polymer fiber 12. Thus, it is possible to restrict the gap Cr (see FIG. 4) from being created between the heating wire 14 and the polymer fiber 12 by the urging force of the urging member 20.

For example, the urging member 20 is wound on the outer side of the heating wire 14 in the fiber radial direction DRr over the entire length of the wound portion 122 (see FIG. 1) of the polymer fiber 12.

As described above, according to the present embodiment, the urging member 20 of the actuator device 10 urges the heating wire 14 to be pressed against the polymer fiber 12. Therefore, even if the polymer fiber 12 is plastically deformed by being pressed by the heating wire 14 due to the thermal expansion of the polymer fiber 12, the state in which the heating wire 14 is pressed against the polymer fiber 12 is maintained by the urging force of the urging member 20. Therefore, it is possible to restrict the thermal resistance between the heating wire 14 and the polymer fiber 12 from increasing due to heating of the polymer fiber 12.

Due to the urging member 20, the present embodiment has no restriction that the heating wire 14 is wound around the polymer fiber 12 so that the winding angle θa at the lower limit temperature falls within the winding angle allowable range We in FIG. 7. In the present embodiment, the pressed portion 121 of the polymer fiber 12 may be plastically deformed by being pressed by the heating wire 14 with the thermal expansion of the polymer fiber 12.

Aside from the above described aspects, the present embodiment is the same as the first embodiment. Further, in the present embodiment, the same effects as the first embodiment described above can be obtained in the same manner as in the first embodiment.

Note that the present embodiment is a modification based on the first embodiment, but it is possible to combine the present embodiment with the second embodiment or the third embodiment.

### Fifth Embodiment

A fifth embodiment is described next. The present embodiment will be explained mainly with respect to portions different from those of the first embodiment.

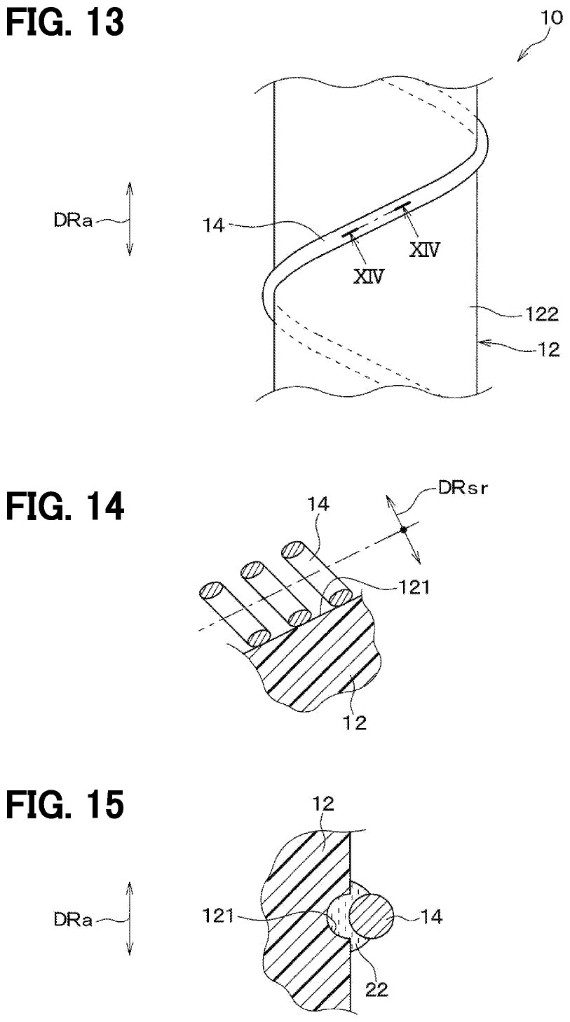

As shown in FIGS. 13 and 14, in the present embodiment, the configuration of the heating wire 14 is different from that of the first embodiment.

Specifically, the heating wire 14 of the present embodiment is not a wire rod that simply extends, and the heating wire 14 is configured in the shape of a coil spring that extends in the longitudinal direction of the heating wire 14. The heating wire 14 shaped in the coil spring is wound around the outer surface of the polymer fiber 12. Therefore, the heating wire 14 has elasticity that elastically deforms in the radial direction DRsr of the heating wire 14, and the elasticity always presses the pressed portion 121 of the polymer fiber 12.

With such a configuration, even if the polymer fiber 12 is plastically deformed by being pressed by the heating wire 14 due to the thermal expansion of the polymer fiber 12, the state in which the heating wire 14 presses the polymer fiber 12 is maintained by the elasticity of the heating wire 14. That is, due to the elasticity of the heating wire 14, it is possible to restrict a gap Cr (see FIG. 4) from being created between the heating wire 14 and the polymer fiber 12. Therefore, it is possible to restrict the thermal resistance between the heating wire 14 and the polymer fiber 12 from increasing due to heating of the polymer fiber 12.

Further, due to the elasticity of the heating wire 14, there is no restriction in this embodiment that the heating wire 14 is wound around the polymer fiber 12 so that the winding angle θa at the lower limit temperature falls within the winding angle allowable range Wθ of FIG. 7. Then, in the present embodiment, the pressed portion 121 of the polymer fiber 12 may be plastically deformed by being pressed by the heating wire 14 with the thermal expansion of the polymer fiber 12.

Aside from the above described aspects, the present embodiment is the same as the first embodiment. Further, in the present embodiment, the same effects as the first embodiment described above can be obtained in the same manner as in the first embodiment.

The present embodiment is a modification based on the first embodiment and can also be combined with any of the second to the fourth embodiments.

### Sixth Embodiment

A sixth embodiment is described next. The present embodiment will be explained mainly with respect to portions different from those of the first embodiment.

As shown in FIG. 15, the actuator device 10 of the present embodiment includes grease 22. The present embodiment is different from the first embodiment in this point.

Specifically, the grease 22 of the present embodiment is a heat conductive grease that conducts heat, and functions as, for example, a heat conductive material having high heat conductivity. The heating wire 14 is wound, as shown in FIG. 1. In detail, as shown in FIG. 15, the heating wire 14 is wound around the outer surface of the polymer fiber 12 with the grease 22 interposed between the polymer fiber 12 and the heating wire 14.

For example, the grease 22 is interposed between the polymer fiber 12 and the heating wire 14 over the entire length of the wound portion 122 (see FIG. 1) of the polymer fiber 12. Therefore, the heat of the heating wire 14 is transferred to the polymer fiber 12 via the grease 22. That is, the grease 22 makes it possible to restrict a gap Cr (see FIG. 4) from being created between the heating wire 14 and the polymer fiber 12.

Then, it is possible to restrict the polymer fiber 12 from being plastically deformed by being pressed by the heating wire 14 by the grease 22 that is movable between the polymer fiber 12 and the heating wire 14.

Due to the grease 22, the present embodiment has no restriction that the heating wire 14 is wound around the polymer fiber 12 so that the winding angle θa at the lower limit temperature falls within the winding angle allowable range We of FIG. 7.

Aside from the above described aspects, the present embodiment is the same as the first embodiment. Further, in the present embodiment, the same effects as the first embodiment described above can be obtained in the same manner as in the first embodiment.

The present embodiment is a modification based on the first embodiment and can also be combined with any of the second to the fifth embodiments.

### Other Embodiments

(1) In each of the embodiments, the polymer fiber 12 of FIG. 1 expands in the fiber radial direction DRr and contracts in the fiber axial direction DRa while being twisted and deformed as the temperature of the polymer fiber 12 increases. However, this is an example. The deformation of the polymer fiber 12 in response to a change in temperature need not be limited to such deformation. For example, the polymer fiber 12 may not have to be twisted.

(2) In each of the embodiments, as shown in FIG. 1, the polymer fiber 12 extends linearly, but does not have to extend linearly as shown in FIG. 1. For example, the polymer fiber 12 may have a spiral shape. In that case, the fiber axial direction DRa is along the spiral shape.

(3) In each of the embodiments, the operating member of the actuator device 10 is the polymer fiber 12, but the operating member may be made of a material other than the polymer fiber 12. Further, in the actuator device 10, the heating member is the heating wire 14, but the heating member may be made of a material other than the heating wire 14. Furthermore, the heating member may generate heat by means other than electric energization.

(4) In each of the embodiments, as shown in FIGS. 1 and 3, the heating wire 14 is shaped in a wire, but is not limited to this, and may be in the shape of a strip, for example.

(5) Note that the present disclosure is not limited to the embodiment described above, and can be variously modified. The above embodiments are not independent of each other, and can be appropriately combined except when the combination is obviously impossible.

Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### (Overview)

According to the first aspect shown in part or all of the above embodiments, the operating member deforms in response to change in temperature within a range in which the stress generated between the operating member and the heating member remains at or below the elastic limit of the operating member.

Further, according to the second aspect, the operating member has a wire rod shape and has a pressed portion pressed by the heating member. The temperature is changed between a predetermined lower limit temperature and a predetermined upper limit temperature higher than the lower limit temperature. The heating member is wound around the outer surface of the operating member, and presses the pressed portion inward in a radial direction of the operating member by being pulled as the temperature of the operating member increases. The stress is a compressive stress generated in the pressed portion while pressing by the heating member, and the compressive stress generated in the pressed portion when the operating member has the upper limit temperature is equal to or less than the elastic limit. Therefore, in the actuator device configured by winding the heating member around the outer surface of the operating member, it is possible to avoid plastic deformation of the operating member due to the heating member.

Further, according to the third aspect, the operating member has a wire rod shape, and expands in a radial direction of the operating member and contracts in an axial direction of the operating member as the temperature of the operating member increases. The heating member is wound around the outer surface of the operating member. The operating member is changed in temperature between a predetermined lower limit temperature and a predetermined upper limit temperature higher than the lower limit temperature. An imaginary state is assumed where the heating member is removed from the operating member while the winding locus of the heating member is left on the outer surface of the operating member. In this state, a difference between a pre-heating length of the winding locus when the operating member has a lower limit temperature and an after-heating length of the winding locus when the operating member has an upper limit temperature is less than or equal to a predetermined limit value corresponding to the elastic limit of the operating member.

Therefore, the stress generated between the operating member and the heating member can be kept at or below the elastic limit of the operating member by the winding of the heating member around the operating member.

Further, according to the fourth aspect, as the temperature of the operating member increases, the operating member expands in the radial direction and contracts in the axial direction while being twisted and deformed. The heating member is spirally wound around the outer surface of the operating member at a predetermined winding angle. Then, the locus length difference is obtained as ΔJ in Formula F8.

Therefore, by using Formula F8, it is possible to determine how to wind the heating member around the operating member so that the stress generated between the operating member and the heating member remains at or below the elastic limit of the operating member. Then, it is possible to wind the heating member after determining how to wind the heating member in advance.

Further, according to the fifth aspect, the limit value is a locus length difference when the stress reaches the elastic limit as the operating member is brought to the upper limit temperature. Therefore, it is possible to avoid plastic deformation of the operating member by the heating member, and it is possible to maximize the permissible range of the winding of the heating member.

Further, according to the sixth aspect, the operating member is in the form of a wire rod. The heating member has a wire shape, and an elastic member is interposed between the operating member and the heating member and wound around the outer surface of the operating member. Then, the elastic member has elasticity and is elastically deformed by being compressed by the operating member and the heating member as the operating member deforms according to the change in temperature. Therefore, the heat of the heating member can be transferred to the operating member via the elastic member, and the operating member can be restricted from plastic deformation by being pressed by the heating member due to the elastic deformation of the elastic member.

Further, according to the seventh aspect, the operating member is in the form of a wire rod. The heating member is in the form of a wire rod, and is wound around the outer surface of the operating member with grease interposed between the operating member and the heating member. Therefore, the heat of the heating member can be transferred to the operating member via the grease. Then, it is possible to restrict the operating member from being plastically deformed by being pressed by the heating member due to the flow of the grease between the operating member and the heating member.

Further, according to the eighth aspect, the actuator device includes: a wire-shaped operating member that deforms in response to a change in temperature; a wire-shaped heating member wound around the outer surface of the operating member to heat the operating member; and an urging member that urges the heating member to be pressed onto the operating member.

Further, according to the ninth aspect, the actuator device includes a wire-shaped operating member that deforms in response to a change in temperature, and a wire-shaped heating member wound around the outer surface of the operating member to heat the operating member. The heating member has elasticity that elastically deforms in the radial direction of the heating member, and the operating member is pressed by the elasticity.

Further, according to the tenth aspect, the actuator device includes a wire-shaped operating member that deforms in response to a change in temperature, and a heating member that applies heat to the operating member. The operating member expands in the radial direction of the operating member as the temperature of the operating member increases, and the heating member is provided so as to extend along the axial direction of the operating member.

Further, according to the eleventh aspect, the method of manufacturing the actuator device includes preparing an operating member and a heating member, and after the preparing, winding the heating member on the outer surface of the operating member according to the winding locus of the heating member assumed around the outer surface of the operating member. In the winding, the winding locus is determined so that the difference between the pre-heating length of the winding locus and the after-heating length of the winding locus is equal to or less than a predetermined limit value based on the elastic limit of the operating member. The pre-heating length of the winding locus is the length of the winding locus when the operating member before winding the heating member has a lower limit temperature. The after-heating length of the winding locus is the length of the winding locus when the operating member before winding the heating member has an upper limit temperature.

What is claimed is:

1. An actuator device comprising:
an operating member that deforms in response to a change in temperature; and
a heating member that applies heat to the operating member, wherein
the operating member deforms in response to a change in temperature within a range in which a stress generated between the operating member and the heating member remains at or below an elastic limit of the operating member,
the operating member has a wire rod shape, and expands in a radial direction of the operating member and contracts in an axial direction of the operating member as a temperature of the operating member increases,
the heating member is wound around an outer surface of the operating member,
the operating member is changed in temperature between a predetermined lower limit temperature and a predetermined upper limit temperature higher than the lower limit temperature,
a winding locus of the heating member has a pre-heating length when the operating member has the lower limit temperature before the heating member is wound in an imaginary state where the heating member is removed from the operating member while the winding locus of the heating member is left on the outer surface of the operating member,
the winding locus of the heating member has an after-heating length when the operating member has the upper limit temperature in the imaginary state, and
a locus length difference between the pre-heating length and the after-heating length is less than or equal to a predetermined limit value corresponding to the elastic limit of the operating member.

2. The actuator device according to claim 1, wherein
the operating member has a pressed portion pressed by the heating member,
the heating member presses the pressed portion inward in the radial direction by being pulled as the temperature of the operating member increases,
the stress is a compressive stress applied to the pressed portion by the heating member, and
the compressive stress, when the operating member has the upper limit temperature, is less than or equal to the elastic limit.

3. The actuator device according to claim 1, wherein
the operating member expands in the radial direction, contracts in the axial direction, and deforms and twists as the temperature of the operating member increases,
the heating member is spirally wound around the outer surface of the operating member at a predetermined winding angle, and
the locus length difference is obtained as ΔJ in Formula of
$$Δ J = \sqrt{\begin{matrix}{[ ( N + γ \text{/} 360 ) ( 1 + α \cdot t ) π d ]}^{2} + \\ {[ ( 1 + β \cdot t ) L ]}^{2}\end{matrix}} - \sqrt{{( N π d )}^{2} + {L}^{2}}$$
wherein N represents a winding number of the heating member wound around the operating member at the lower limit temperature, L represents an axial length of a wound portion of the operating member around which the heating member is wound at the lower limit temperature, d represents a diameter of the wound portion at the lower limit temperature, α represents a coefficient of thermal expansion of the operating member in the radial direction when an expansion side is defined as a positive direction, β represents a coefficient of thermal expansion of the operating member in the axial direction when an expansion side is defined as a positive direction, t represents a temperature difference between the lower limit temperature and the upper limit temperature, and γ represents a twist angle of the wound portion when the temperature of the operating member is raised from the lower limit temperature to the upper limit temperature with a unit of deg in a positive direction in which the operating member deforms and twists in a same direction as a winding direction of the heating member.

4. The actuator device according to claim 1, wherein the limit value is the locus length difference when the stress reaches the elastic limit as the operating member is made to have the upper limit temperature.

5. The actuator device according to claim 1, further comprising an elastic member having elasticity, wherein
the heating member is wound around the outer surface of the operating member with the elastic member interposed between the operating member and the heating member, and
the elastic member is elastically deformed by being compressed by the operating member and the heating member in response to change in temperature of the operating member.

6. The actuator device according to claim 1, further comprising a heat-transmitting grease, wherein
the heating member is wound around the outer surface of the operating member with the grease interposed between the operating member and the heating member.

7. An actuator device comprising:
an operating member having a wire rod shape and configured to deform in response to change in temperature;
a heating member wound around an outer surface of the operating member and configured to apply heat to the operating member; and
an urging member that urges the heating member to be pressed against the operating member.

8. An actuator device comprising:
an operating member having a wire rod shape and configured to deform in response to change in temperature; and
a heating member wound around an outer surface of the operating member and configured to apply heat to the operating member, wherein
the heating member has elasticity that elastically deforms in a radial direction of the heating member, and presses the operating member by the elasticity.

9. An actuator device comprising:
an operating member having a wire rod shape and configured to deform in response to change in temperature; and
a heating member that applies heat to the operating member, wherein
the operating member expands in a radial direction of the operating member as the temperature of the operating member increases, and
the heating member is provided so as to extend along an axial direction of the operating member.

10. A method for manufacturing the actuator device according to claim 1 comprising:
determining the winding locus such that the difference between the pre-heating length of the winding locus and the after-heating length of the winding locus is less than or equal to the predetermined limit value corresponding to the elastic limit of the operating member; and
winding the heating member around the outer surface of the operating member according to the winding locus of the heating member.
